(19) United States
(12) Patent Application Publication
(10) Pub. No.: US 2005/0125614 A1
(43) Pub. Date: Jun. 9, 2005

(54) Adaptive layout cache organization to enable optimal cache hardware performance

(76) Inventor: Robert J. Royer JR., Portland, OR (US)

Correspondence Address: INTEL CORPORATION, P.O. BOX 5326, SANTA CLARA, CA, 95056-5326, US

(21) Appl. No.: 10/732,574

(22) Filed: Dec. 9, 2003

(51) Int. Cl. G06F 12/00

(52) U.S. Cl. 711/137; 711/113

(57) ABSTRACT

A cache memory mapping algorithm and associated hardware maps cache lines in a manner such that each set contains cache lines from only one cache memory chip. Sequential disk accesses are mapped to sequential sets to allow stored data to be retrieved simultaneously from different cache storage chips. The cache line allocation policy ensures that new cache lines are dynamically inserted into the proper sets and correspond to the correct cache memory chip.

A processor based system that accesses data on a hard disk drive may achieve improved performance by utilizing a cache implemented in solid state memory. The processor populates the cache with data from the disk that is accessed by the system. Since the cache uses a smaller, faster storage device to provide a lower access time, system performance may be improved by speeding up subsequent accesses to the data stored in the cache instead of accesses to the disk.

A well known design for caches, especially disk caches, is an N-way set associative cache whose addresses map to a set based on a computed mapping function. In such a design, the cache may be implemented as a collection of N arrays of cache lines, where each array represents a set. Thus, any element on a disk may be mapped to a set in the cache. To locate an element in the set associative cache, the system uses the address of the data on the disk to compute the set in which the element would reside, and then search through the array representing the set until a match is found, or it is determined that the element is not in the set. Prior art disk caches do not attempt to minimize the number of wordline requests.

There is a need to reduce the number of wordline accesses per disk request and improve the performance of the system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a memory controller and M cache storage chips where features of the present cache mapping algorithm may be incorporated;

FIG. 2 illustrates an embodiment of the cache memory mapping algorithm;

FIG. 3 shows a free list of cache lines available for each of the cache storage chips;

FIG. 4 shows a prior art file system that addresses multiple disk sectors as file system clusters; and

FIG. 5 shows multiple disk sectors as file system clusters addressed in accordance with the present invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

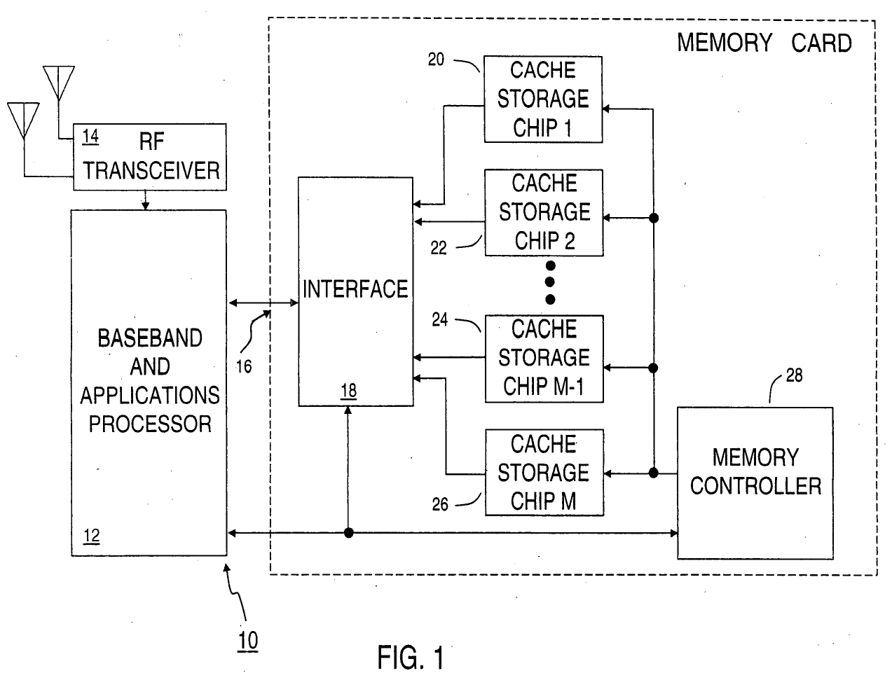

FIG. 1 illustrates a wireless communications device 10 having a transceiver 14 that either receives or transmits a modulated signal from one or more antennas. In such embodiments, the associated antenna may be a dipole antenna, helical antenna, or the like. The analog front end transceiver may be provided as a stand-alone Radio Frequency (RF) integrated analog circuit, or alternatively, be embedded with processor 12 as a mixed-mode integrated circuit. The received modulated signal is frequency down-converted, filtered, then converted to a digital signal. The digital data for the baseband signal processed by processor 12 may be transferred across an interface 16 for storage by the memory devices on a memory card.

A Network Interface Card (NIC) may facilitate the transfer of data across interface 16 and may incorporate a Peripheral Component Interconnect (PCI) bus as defined by the PCI Local Bus Specification, dated in June 1995, or alternately, a bus such as the PCI Express bus or any other high bandwidth bus. The metadata used by the cache management system for administrative purposes, along with the data processed by processor 12, may be stored by cache storage chips. By way of example and for ease of description, the memory card shown in FIG. 1 has four cache storage chips 20, 22, 24 and 26, but it should be noted that any number of cache devices may populate the memory card. In one embodiment, each of the four cache storage chips has a memory size of 256 Mbit, but the size of the memory is not a limitation. Further, cache storage chips 20, 22, 24 and 26 may be separate packaged devices or integrated together and addressable as separate blocks of memory. A memory controller 28 on the memory card is connected via address and control signals to the cache storage chips. Memory controller 28 implements a cache mapping algorithm to improve the performance of wireless communications device 10.

Cache storage chips 20, 22, 24 and 26 may be a relatively large non-volatile disk cache memory adapted to cache information for a mass storage (not shown) coupled to processor 12. The mass storage device typically has a storage capacity, for example, of at least about one gigabyte. The mass storage device may be an electromechanical hard disk memory, an optical disk memory, or a magnetic disk memory, although the scope of the present invention is not limited in this respect.

In one embodiment, cache storage chips 20, 22, 24 and 26 may be a polymer memory having a storage capacity of at least about 250 megabytes and may include ferroelectric memory cells, wherein each cell includes a ferroelectric polymer material located between at least two conductive lines. In this embodiment the ferroelectric polymer material may be a ferroelectric polarizable material and include a ferroelectric polymer material comprised of a polyvinyl fluoride, a polyethylene fluoride, a polyvinyl chloride, a polyethylene chloride, a polyacrylonitrile, a polyamide, copolymers thereof, or combinations thereof.

In an alternate embodiment, cache storage chips 20, 22, 24 and 26 may be a polymer memory such as, for example, a plastic memory or a resistive change polymer memory. In this embodiment, the plastic memory may include a thin film of polymer memory material sandwiched at the nodes of an address matrix. The resistance at any node may be altered from a few hundred ohms to several megohms by an electric potential supplied across the polymer memory material and a positive or negative current flowing in the polymer material that alters the resistance of the polymer material. Potentially, different resistance levels may store several bits per cell and data density may be increased further by stacking layers. In addition to polymer memory, Cache storage chips 20, 22, 24 and 26 may be a NOR or NAND Flash, or battery backed up DRAM.

Mass storage disk drives can uniquely address 512 byte blocks of data at a time, commonly called a disk sector, and accordingly, the disk cache illustrated on the memory card of wireless communications device 10 typically maintains the same addressing granularity. Multiple addressable ‘disk sectors’ or blocks may be stored on each cache line of cache storage chips 20, 22, 24 and 26, along with some cache metadata. An offset array may be set in system memory where the number of offsets in the array may be selected to be the number of disk sectors per wordline for the disk cache. For example, for a disk cache having 4 KB per wordline, 8 disk sectors may be stored per wordline. Thus, the offset array may have 8 entries to represent the 8 disk sectors.

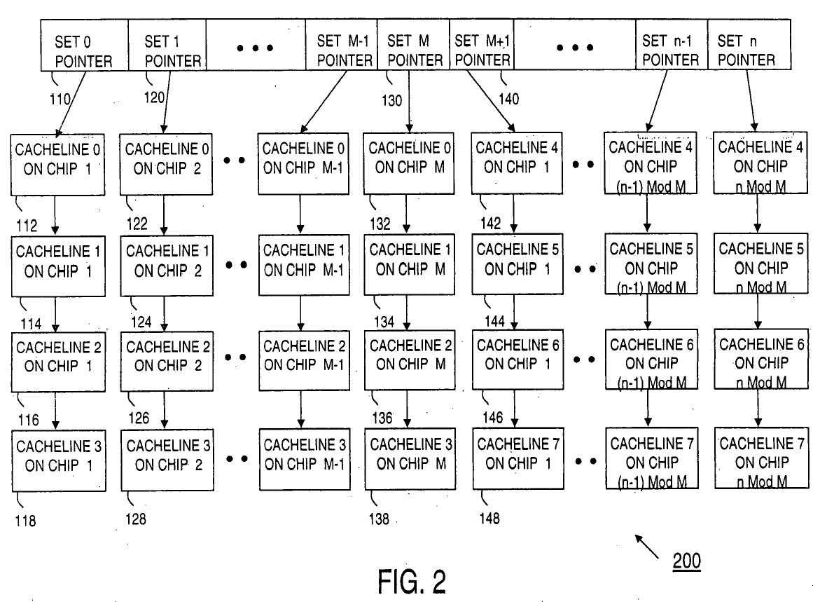

FIG. 2 illustrates the cache memory mapping algorithm 200 enforced by memory controller 28 (see FIG. 1). In this embodiment, data structures and search algorithms ensure parallel hardware operation of the M storage chips, where M in this example is four as shown by cache storage chips 20, 22, 24 and 26 (see FIG. 1). The data structures and cache memory mapping algorithm define the mapping of disk sectors to the appropriate cache lines to provide an improvement in system performance. The mapping algorithm first converts disk Logical Block Addresses (LBAs) to sets as shown by set 0, set 1, . . . , set M, etc. Logical block addressing is a technique that allows a computer to address a hard disk, where a 48-bit LBA value allows mapping to a specific cylinder-head-sector address on the disk.

FIG. 2 further shows the corresponding cache lines mapped to the various sets. For instance, set 0 (indicated by the reference number 110) corresponds to chip 1, i.e., cache storage chip 20 in FIG. 1. Set 0 has an attached list that includes an arbitrary number of cache lines 112, 114, 116 and 118 that correspond to respective cache lines 0, 1, 2, and 3 on chip 1 (see FIG. 1). Likewise, set 1 (indicated by the reference number 120) corresponds to chip 2, i.e., cache storage chip 22 in FIG. 1. Set 1 has an attached list that includes an arbitrary number of cache lines 122, 124, 126 and 128 that correspond to respective cache lines 0, 1, 2, and 3 on chip 2 (see FIG. 1). Continuing, the attached list for set M also includes an arbitrary number of cache lines 132, 134, 136 and 138 that correspond to respective cache lines 0, 1, 2, and 3 on chip M (see FIG. 1). Set M+1 (indicated by the reference number 140) wraps around to again correspond to chip 1, i.e., cache storage chip 20 in FIG. 1. The list attached to set M+1 includes an arbitrary number of cache lines 142, 144, 146 and 148 that correspond to respective cache lines 4, 5, 6 and 7 on chip 1 (see FIG. 1). This layout of sets and attached lists is repeated until all the cache lines have been populated into the various sets.

In accordance with the present invention, a hash function may receive a continuous user demand request that spans multiple cache lines. In this case, the cache memory mapping algorithm 200 controls the hash function to provide mapping that spans continuous sets. In the illustrated mapping scheme, adjacent sets have cache lines for different cache storage chips. Note that cache lines for each set are mapped in a manner such that each set contains cache lines from only one cache memory chip. Further note that contiguous addresses are mapped to adjoining sets, or put another way, sequential disk accesses are mapped to sequential sets to allow stored data to be retrieved simultaneously from different cache storage chips. By way of example to illustrate this point, user demand for four contiguous addresses would map to four continuous sets, and provide data from four different cache storage chips in substantially one memory access time.

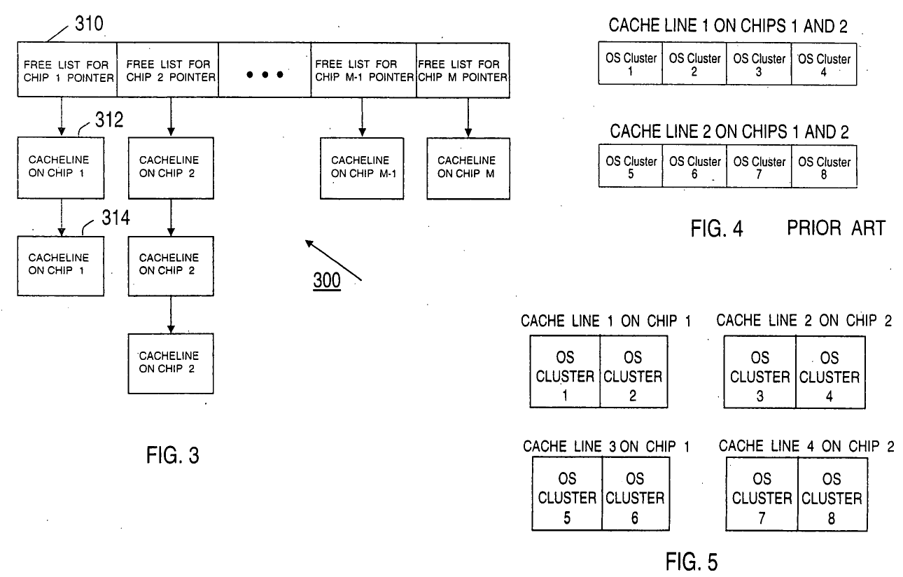

FIG. 3 shows a free list 300 of cache lines available for each of the cache storage chips. Since the cache memory mapping algorithm 200 provides an arbitrary number of cache lines per set, a free list is kept for each cache memory chip. The cache line allocation policy ensures that new cache lines such as, for example, cache lines 312 and 314 are dynamically inserted into the proper sets and correspond to the correct cache memory chip.

FIG. 4 shows file systems may request multiple disk sectors per each input/output (I/O) request, as multiple disk sectors are addressed as one file system cluster, normally in even sector increments to minimize overhead in disk organization. Unfortunately, the first file system cluster may not start at sector zero on the disk drive but at an arbitrary sector offset. Thus, additional cache wordlines are accessed if the mapping of disk to cache address does not naturally align to Operating System (OS) file system clusters. Shown in this example is a request serviced by the cache for OS clusters 3-6 that requires two memory cycles to transfer the data since all OS cluster 1-8 are transferred (entire cache lines are transferred as one unit).

Another case shown in FIGS. 4 and 5 which is also common is a request, for example, for OS Clusters 1-3 in both cases. This results in one memory cycle to get the data, but that case may only occur about 50% of the time with two physical chips due to alignment. All other cases for a 3 OS Cluster read (for example OS Clusters 3-5) results in a two memory cycle read using the prior art method but may still be a single memory cycle read using the disclosed method.

FIG. 5 shows the same request for two 8 Kbyte cache lines serviced by the cache for OS clusters 3-6 that, in accordance with the present invention, is processed by cache memory mapping algorithm 200 in one memory cycle. Note that data transfers are made from both chips 1 and 2, and thus, data accesses in one memory cycle are realized and not two memory cycles as necessitated by prior art service requests. Further note that as the number of chips (M) increases, the probability increases that the disclosed method has significant performance improvements. In the case of four chips, all possible starting OS clusters for a four cluster transfer can be completed in one memory cycle.

Should a reboot of wireless communications device 10 be necessary; (1) each cache line should be scanned to retrieve the metadata; (2) the tag of the cache line should be recovered; (3) the tag should be converted to the set pointer; and (4) the cache should be inserted on the appropriate set.

By now it should be apparent that the present invention for the cache memory mapping algorithm and associated hardware has advantages over prior art disk systems. The hashing function maps cache lines in a manner such that each set contains cache lines from only one cache memory chip. Sequential disk accesses are mapped to sequential sets to allow stored data to be retrieved simultaneously from different cache storage chips. The cache line allocation policy ensures that new cache lines are dynamically inserted into the proper sets and correspond to the correct cache memory chip. These and other features provide a performance improvement.

The principles of the present invention may be practiced in wireless devices that are connected to operate in a variety of communication networks that include cellular networks, Wireless Local Area Networks (WLANs), Personal Area Networks (PANs), 802.11 networks, Ultra Wide Band (UWB), among others. In particular, the present invention may be used in smart phones, communicators and Personal Digital Assistants (PDAs), medical or biotech equipment, automotive safety and protective equipment, and automotive infotainment products. However, it should be understood that the scope of the present invention is not limited to these examples.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A cache memory comprising:
a cache mapping algorithm to map sequential disk accesses to sequential sets.

2. The cache memory of claim 1, wherein a first set of the sequential sets accesses data from a first cache storage chip and a second set accesses data from a second cache storage chip.

3. The cache memory of claim 2, wherein stored data from the first and second cache storage chips is retrieved simultaneously in one memory cycle.

4. The cache memory of claim 2, wherein the cache mapping algorithm hashes cache lines from the first cache storage chip to the first set and cache lines from the second cache storage chip to the second set.

5. A cache memory comprising:
first and second cache memory chips; and
a memory controller coupled to the first and second cache memory chips to map sequential disk accesses to sequential sets, where a first set of the sequential sets accesses data from the first cache memory chip and a second set accesses data from the second memory chip.

6. The cache memory of claim 5 wherein the first set has an attached list that includes an arbitrary number of cache lines in the first cache memory chip.

7. The cache memory of claim 5 wherein the memory controller keeps a free list of cache lines for the first cache memory chip.

8. The cache memory of claim 5 wherein the memory controller ensures that new cache lines are dynamically inserted into the first set and corresponds to the first cache memory chip.

9. The cache memory of claim 5 wherein the first cache memory chip is a polymer memory device.

10. The cache memory of claim 9 wherein the polymer memory device includes memory cells having a ferroelectric polymer material.

11. The cache memory of claim 9 wherein the polymer memory device includes memory cells having a resistive change polymer material.

12. The cache memory of claim 5 wherein the first cache memory chip is a FLASH memory device.

13. The cache memory of claim 5 wherein the first cache memory chip is a Dynamic Random Access Memory (DRAM) device.

14. A method comprising:
simultaneously accessing data corresponding to sequential disk accesses from a plurality of memory chips in one memory cycle.

15. The method of claim 14, further comprising:
using a cache mapping algorithm to map sequential disk accesses to sequential sets.

16. The method of claim 15, wherein the cache mapping algorithm further comprises:
hashing a first set to access data from a first cache storage chip and a second set to access data from a second cache storage chip.

17. The method of claim 16, further comprising:
accessing stored data from the first and second cache storage chips simultaneously.

18. The method of claim 17, wherein accessing stored data from the first and second cache storage chips is in one memory cycle.

19. A system, comprising:
a transceiver to receive first and second signals through respective first and second antennas;
a processor coupled to the transceiver to receive the first and second signals;
first and second cache memory blocks coupled to the processor; and
a memory controller to run a cache mapping algorithm to map sequential disk accesses to sequential sets that access data from the first and second cache memory blocks.

20. The system of claim 19 further comprising accessing data from the first and second cache memory blocks in one memory cycle.

21. The system of claim 19 wherein the first and second cache memory blocks are integrated together on one substrate.

22. The system of claim 19 wherein the first and second cache memory blocks include polymer memory devices.

23. The system of claim 19 wherein each set in the sequential sets contains cache lines from only one cache memory block.

24. The system of claim 19 wherein the cache mapping algorithm dynamically inserts new cache lines into at least one of the sequential sets.
